(19) United States
(12) Patent Application Publication
(10) Pub. No.: US 2015/0176618 A1
(43) Pub. Date: Jun. 25, 2015

(54) FASTENER DEVICE

(71) Applicant: Mattson Thomas Thieme, Beaverton, OR (US)

(72) Inventor: Mattson Thomas Thieme, Beaverton, OR (US)

(21) Appl. No.: 14/517,580

(22) Filed: Oct. 17, 2014

Related U.S. Application Data
(60) Provisional application No. 61/964,034, filed on Dec. 23, 2013.

(51) Int. Cl. F16B 2/24; B21D 49/00; B21F 45/22; B21D 53/36

(52) U.S. Cl. CPC F16B 2/248; B21D 53/36; B21D 49/00; B21F 45/22

(57) ABSTRACT

A fastener device includes two generally S-shaped portions defining a generally heart-shaped interior region, the S-shaped portions each including an anchor segment connected to a coupler segment connected to a catch segment. The connection between the anchor segment and the coupler segment defines an anchor angle of less than 90 degrees and the connection between the catch segment and the coupler segment defines a catch angle of less than 90 degrees. The anchor segments are connected to define a bridge angle outside the interior region of less than 180 degrees.

### CROSS-REFERENCE TO RELATED APPLICATIONS

This application claims priority to U.S. Provisional Patent App. No. 61/964,034, filed on Dec. 23, 2013, and hereby incorporated by reference herein.

### TECHNICAL FIELD

Embodiments described herein generally relate to fastener devices.

### BACKGROUND

Fastener devices may be used to couple pieces of material to one another.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a top view of a fastener device according to one embodiment.

FIG. 2 illustrates a top view of fastener device including caps according to one embodiment.

FIG. 3 illustrates the fastener device of FIG. 2 installed in a first piece of fabric.

FIG. 4 illustrates the fastener device of FIG. 2 coupling a first piece of fabric to a second piece of fabric.

FIG. 5 is a flowchart illustrating a method of manufacturing a fastener device according to one embodiment.

FIG. 6 is a flowchart illustrating a method of using a fastener device according to one embodiment.

FIG. 7A illustrates an embodiment of a fastener device including a single anchor segment.

FIG. 7B illustrates an embodiment of a fastener device including two anchor segments.

FIG. 8A illustrates an embodiment of a fastener device including catch segments perpendicular to an axis of symmetry.

FIG. 8B illustrates an embodiment of a fastener device including catch segments forming greater than 90 degree angles.

FIG. 9 illustrates an embodiment of a fastener device with extended coupler segments.

FIG. 10A illustrates an embodiment of a fastener device with an open interior region.

FIG. 10B illustrates an embodiment of a fastener device with connections that cross at a crossing.

### DESCRIPTION OF EMBODIMENTS

A fastener device may be used to fasten two pieces of sturdy cloth together, such as on pants, shorts, backpacks, belts, or climbing equipment. The fastener device may be installed with only a sharp object, such as an awl, and without sewing. The fastening device includes potential energy wells which keep the fastener device flush, minimizing possible catching on foreign objects. The fastener device spreads its load over two contact points in both a receiving aperture and on fabric in which it is installed. The two contact points (at each of both ends) of this fastener may lead to a much more even force distribution around a waistband. This may increase the user's safety by keeping them more comfortable and able to concentrate on the work at hand.

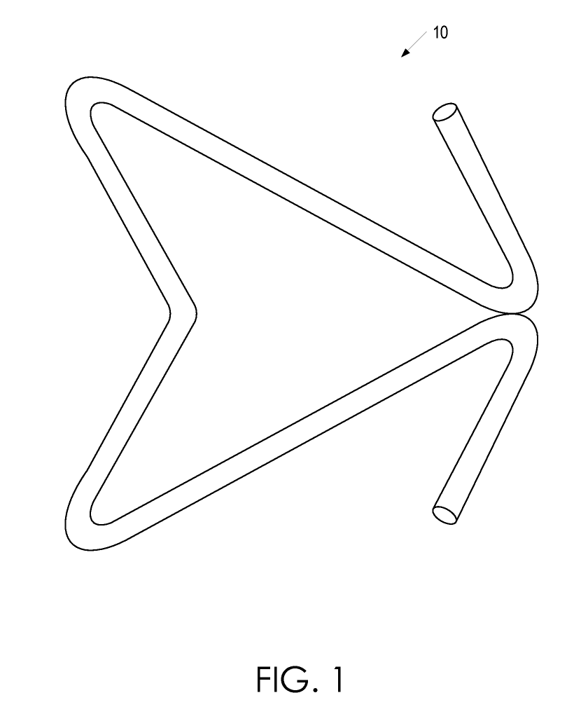

FIG. 1 illustrates a top view of a fastener device 10 according to one embodiment. The fastener device 10 may be of a unitary construction, formed of a single piece of homogenous material. For example, the fastener device 10 may be formed by bending a solid cylindrical metal wire at appropriate locations. The metal wire may, for example, be a 12 to 14 gauge steel wire, comparable to a wire coat hanger. The fastener device 10 may be formed of other materials. The fastener device 10 includes a number of connected segments. The fastener device 10 may be substantially flat such that each segment of the fastener device 10 lies in the same plane.

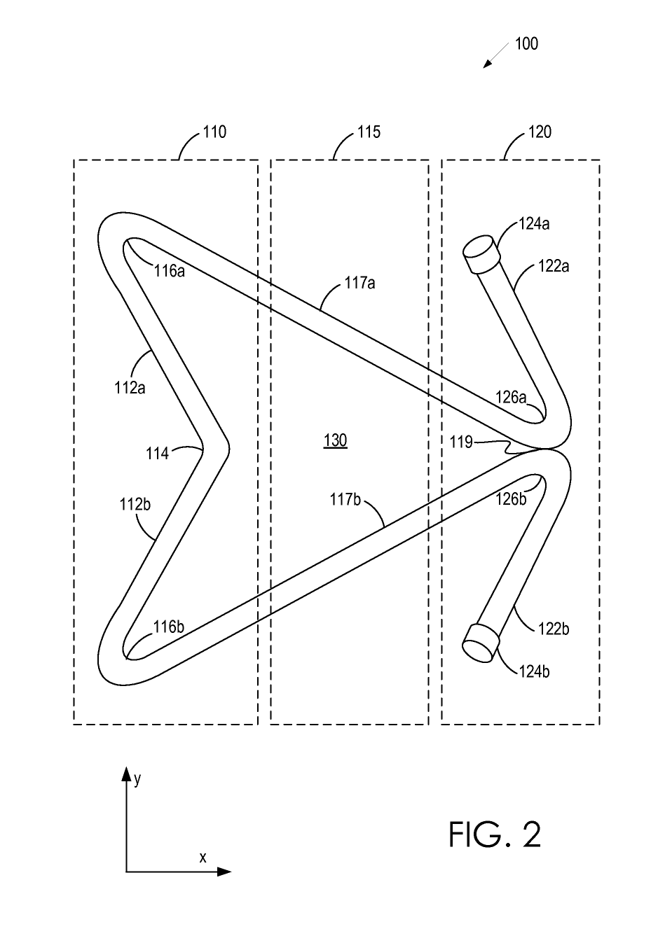

FIG. 2 illustrates a top view of fastener device 100 including caps 124a-124b according to one embodiment. The fastener device 100 may be of a unitary construction, formed of a single piece of homogenous material. For example, the fastener device 100 may be formed by bending a solid cylindrical metal wire at appropriate locations. The metal wire may, for example, be a 12 to 14 gauge steel wire, comparable to a wire coat hanger. The fastener device 100 may be formed of one or more of metal, plastic, rubber, or any other material. The fastener device 100 includes a number of connected segments. The fastener device 100 may be substantially flat such that each segment of the fastener device 100 lies in the same plane.

The fastener device 100 is generally symmetric across the x-axis with a generally S-shaped portion on either side of the x-axis. The two S-shaped portions enclose a generally heart-shaped interior region 130.

The fastener device 100 includes an anchor portion 120 coupled to a catch portion 120 by a coupler portion 115. The anchor portion 110 includes two anchor segments 112a-112b. Each anchor segment 112a-112b is connected, at a first end, to the other anchor segment 112a-112b and connected, at a second end, to a coupler segment 117a-117b of the coupler portion 115. The catch portion 120 includes two catch segments 122a-122b. Each catch segment 122a-122b is connected, at a first end, to a coupler segment 117a-117b of the coupler portion 115 and free, at a second end.

As noted above, each anchor segment 112a-112b is connected, at a first end, to the other anchor segment 112a-112b. This connection 114 may define a bridge angle facing away from the interior portion 130. The bridge angle may be less than 180 degrees. In particular, the bridge angle may be acute, right, or obtuse. In one embodiment, the bridge angle is approximately 100-110 degrees.

As also noted above, each anchor segment 112a-112b is connected, at a second end, to a coupler segment 117a-117b of the coupler portion 115. Each of these connections 116a-116b may define an anchor angle facing towards the interior portion 130. The anchor angle may be less than 90 degrees. In one embodiment, the anchor angle is approximately 40-50 degrees.

As noted above, each catch segment 122a-122b is connected, at a first end, to a coupler segment 117a-117b of the coupler portion 115. Each of these connections 126a-126b may define a catch angle facing away from the interior portion 130. The catch angle may be less than 90 degrees. In one embodiment, the catch angle is approximately 20-40 degrees.

As also noted above, each catch segment 122a-122b may be free, at a second end. Each catch segment 122a-122b may include a cap 124a-124b at the second end. The cap 124a-124b may be integral with the catch segment 122a-122b and be defined by machining smooth or polishing the second end of the catch segment 122a-122b to reduce abrasion of fabric near the cap 124a-124b. Alternatively, the cap 124a-124b may be a separate piece that is installed upon the second end of the catch segment 122a-122b. For example, the cap 124a-124a may be a coating of thermoset plastic or polypropylene. In one embodiment, the entire fastener device 100 is coated in a thermoset plastic or other material.

The coupler portion 115 includes two coupler segments 117a-117b. Each of the coupler segments 117a-117b is connected, at a first end, to an anchor segment 112a-112b at an anchor-coupler connection 116a-116b and connected, at a second end, to a catch segment 122a- 122b at a catch-coupler connection 126a-126b. The catch-coupler connections 126a-126b may define a coupler-coupler connection 119 having a coupler angle facing towards the interior portion 130. The coupler angler may be less than 90 degrees. In one embodiment, the coupler angle is approximately 50-70 degrees. In one embodiment, the coupler segments 117a-117b do not touch. Thus, the interior region 130 may not be completely bounded by the fastener device 100.

In one embodiment, the catch segments 122a-122b may be generally parallel to the anchor segments 112a-112b. In one embodiment, the catch angles may be approximately equal to the angles. In one embodiment, the sum of the coupler angle and both catch angles may be less than 180 degrees.

The fastener device 100 may be any size and may have many different proportions based on the lengths of the segments and the various defined angles. In one embodiment, the fastener device is approximately 5 cm by 5 cm. For example, the distance between the caps 126a-126b may be approximately 5 cm. The length of the cap segments 122a-122b (e.g., the distance between the cap 124a-124b and the catch coupler connection 126a-126b) may be approximately 2.5 cm. The length of the coupler segments 117a-117b (e.g., the distance between the anchor-coupler connection 116a-116b and the catch-coupler connection 126a-126b) may be approximately 5 cm. As noted above, this length may be any value. For example, the length of the coupler segments 117a-117b may be between 2.5 cm and 7.5 cm. The length of the anchor segments 112a-112b (e.g., the distance between the anchor coupler connection and the anchor connection 114) may be approximately 1.5 cm.

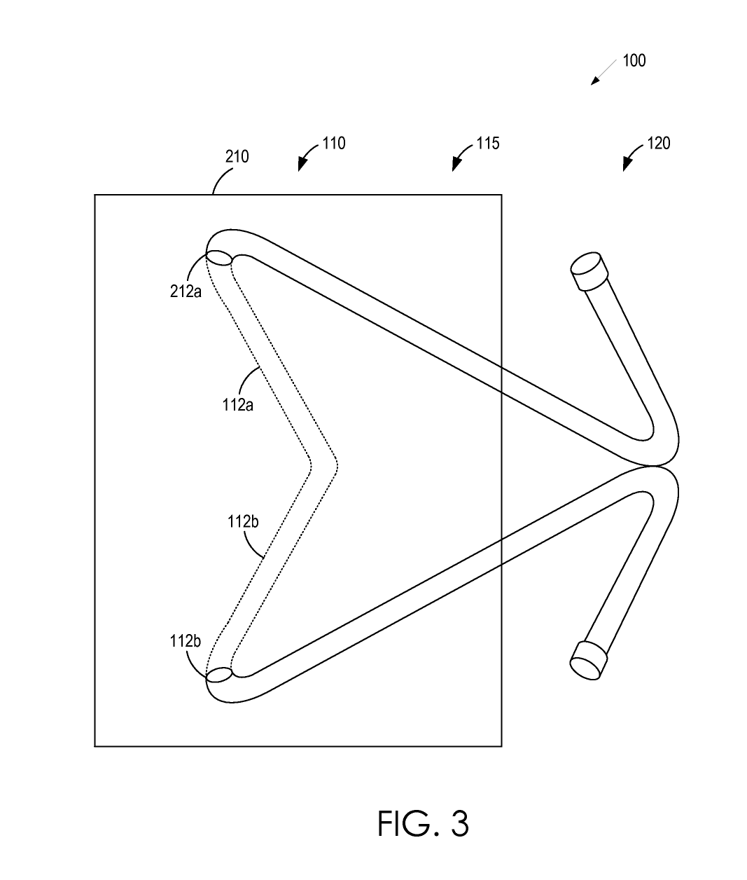

FIG. 3 illustrates the fastener device 100 of FIG. 2 installed in a first piece of fabric 210. The fastener device 100 may be installed by threading the fastening device sequentially through two anchor apertures 212a-212b of the first piece of fabric 210. The two anchor apertures 212a-212b may be formed by an awl or other sharp instrument. Once installed, as shown in FIG. 2, the anchor portion 110 (or at least a portion thereof, such as the anchor segments 112a-112b) is on an opposite side of the first piece of fabric than the coupler portion 115 and the catch portion 120.

The width of the anchor portion 110, as defined by the length of the anchor segments 112a-112b and the anchor angle, prevents rotation of the fastener device 100. Thus, the fastener device 100 remains flush with the first piece of fabric 210 once installed. This may reduce the chance of the fastener device 100 catching on foreign objects.

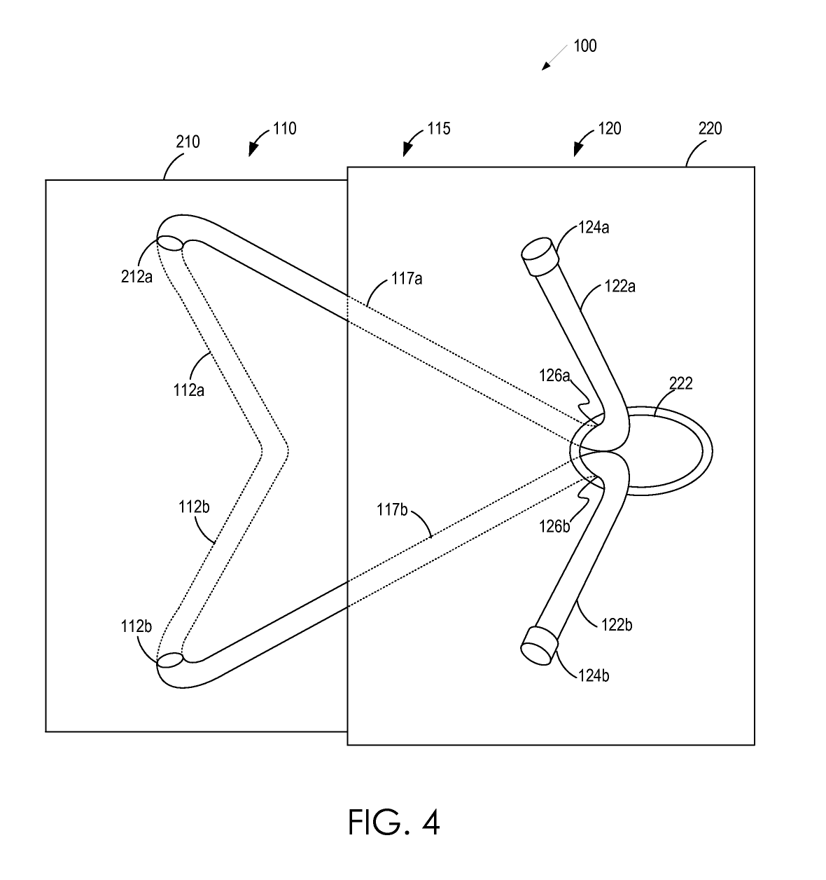

FIG. 4 illustrates the fastener device 100 of FIG. 2 coupling a first piece of fabric 210 to a second piece of fabric 220. The fabric 210, 220 may be denim, canvas, or any other type of material. The fastener device 100 may be used to couple the fabric 210, 220 by installing the fastener device 100 in the first piece of fabric 210 as described above and inserting the catch portion 120 through a receiving aperture 222 in the second piece of fabric 220. The catch portion 120 may be inserted through the receiving aperture 222 by first inserting the cap 124a of a first one of the catch segments 122a and then inserting the cap 124b of the second one of the catch segments 122b.

A force pulling apart the first piece of fabric 210 and second piece of fabric 220 is spread by the fastener to a number of contact points. At the anchor portion 110, the force is spread to where the fastener device 100 passes through the anchor apertures 212a-212b. Further, portions of the first piece of fabric 210 may be evenly forced towards each anchor aperture 212a-212b, potentially preventing the fastening device 100 from moving out of alignment.

At the catch portion 120, the force is spread to the catch-coupler connections 126a-126b. Further, such a force is unlikely to bend the catch segments (e.g., increase the catch angle) because of the small moment arm between the catch-coupler connections 126a-126b and the point of contact with the second piece of fabric 220.

The coupler segments 117a-117b may be any length. In one embodiment, the coupler segments 117a-117b are of a shorter length such that the second piece of fabric 220 covers all of the coupler segments 117a-117b and may cover the anchor apertures, minimizing the appearance of the fastener device 100. In another embodiment, the coupler segments 117a-117b are of a longer length such that the coupler segments 117a-117b are at least partially exposed, making the fastener device 100 also act as an extender such as may be used for the waistband of pants or shorts. For example, the coupler segments 117a-117b may have a length of approximately twice a length of the catch segments 122a-122b. As another example, the coupler segments 117a-117b may have a length of at least five times a length of the catch segments 122a-122b.

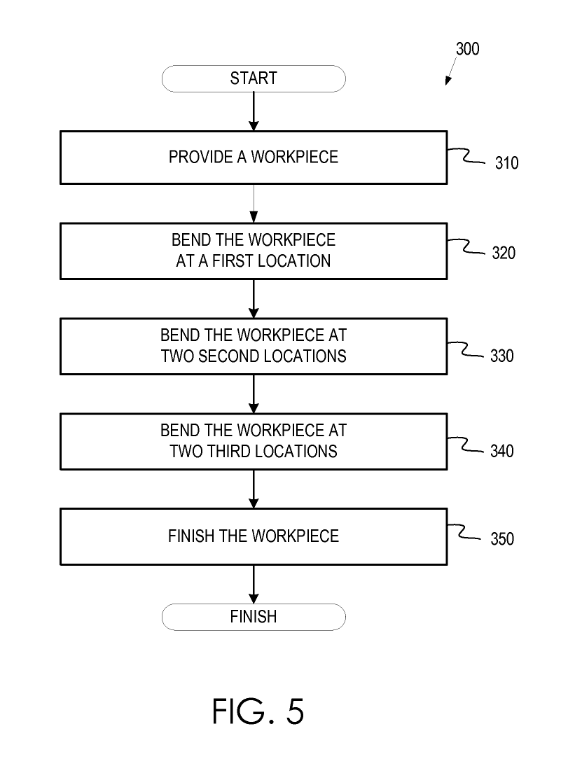

FIG. 5 is a flowchart illustrating a method of manufacturing a fastener device according to one embodiment. The method 300 may be performed to manufacture a fastener device such as the fastener device 100 of FIG. 2.

The method 300 begins, at block 310, with the provision of a workpiece. The workpiece may be a length of solid cylindrical metal wire approximately 20 cm in length.

At block 320, the workpiece is bent at a first location to define an anchor connection, such as the anchor connection 114 of FIG. 2. The workpiece may be bent, for example, by a bending machine applying force at the anchor connection and opposing force on either side of the anchor connection. The first location may be at the center of the workpiece. The workpiece may be bent at the first location to form a bridge angle that may be acute, right, or obtuse. In one embodiment, the bridge angle is approximately 100-110 degrees.

At block 330, the workpiece is bent at two second locations to define anchor-coupler connections, such as the anchor-coupler connections 116a-116b of FIG. 2. The second locations may be between the free ends of the workpiece and the anchor connection. This second bending operation also defines anchor segments between the anchor connection and the anchor-coupler connections. The workpiece may be bent at the second locations to form anchor angles that may be less than 90 degrees. In one embodiment, the anchor angles are approximately 40-50 degrees. The anchor angles and the bridge angle may be on opposite sides of the workpiece. Thus, at block 320, the workpiece is bent in a first direction and, at block 330, the workpiece is bent in an opposite direction.

At block 340, the workpiece is bent at two third locations to define catch-couple connections, such as the catch-coupler connections 126a-126b of FIG. 2. The third locations may be between the free ends of the workpiece and the anchor-coupler connections. This third bending operation also defines coupler segments between the anchor-coupler connections and the catch-coupler connections. The third bending operation also defines catch segments protruding from the catch-coupler connections. The workpiece may be bent at the third locations to form catch angles that may be less than 90 degrees. In one embodiment, the catch angles are approximately 20-40 degrees. The catch angles and the anchor angles may be on opposite sides of the workpiece. Thus, at block 340, the workpiece is bent in the first direction.

The bending operations of block 320-340 may be performed in any order. For example, in one embodiment, the third bending operation of block 340 may be performed before the second bending operation of block 330.

At block 350, the workpiece is finished. The finishing may include placing caps of the free ends of the catch segments. For example, the free ends of the catch segments may be coated in plastic or another material. The finishing may include machining smooth or polishing the free ends of the catch segments to prevent abrasion of other materials. The finishing may include coating the entire workpiece in plastic or another material. The finishing operation of block 350 may be performed, in whole or in part, before or between the bending operations of blocks 320-340. For example, the free ends of the catch segments (e.g., the free ends of the workpiece) may be polished before the bending operations of block 320-340.

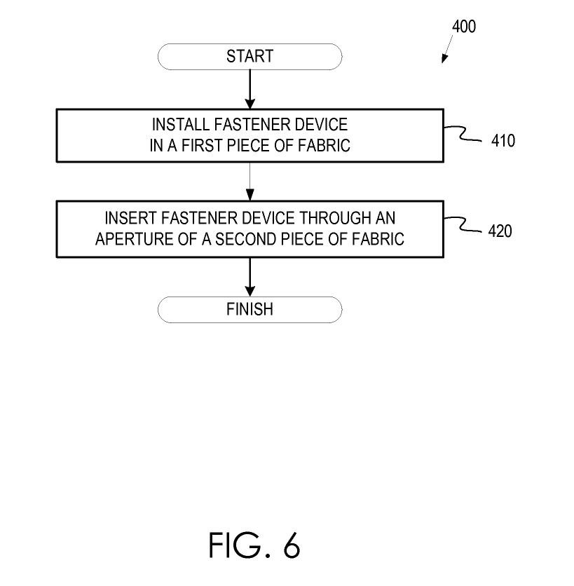

FIG. 6 is a flowchart illustrating a method 400 of using a fastener device according to one embodiment. The method 400 may be performed using a fastener device such as the fastener device 100 of FIG. 2.

At block 410, the fastener device is inserted into a first piece of fabric. In one embodiment, the fastener device may be installed by threading the fastening device sequentially through two anchor apertures of the first piece of fabric. The two anchor apertures may be formed by an awl or other sharp instrument. Once installed, as shown in FIG. 2, an anchor portion of the fastener device (or at least a portion thereof, such as the anchor segments of the fastener device) may be on an opposite side of the first piece of fabric than other portions of the fastener device.

At block 420, the fastener device (or a portion thereof) is inserted into an aperture of a second piece of fabric. In one embodiment, a catch portion of the fastener device may be inserted into the aperture. For example, the catch portion may include two catch segments and the free end of each catch segment may be sequentially inserted into the aperture.

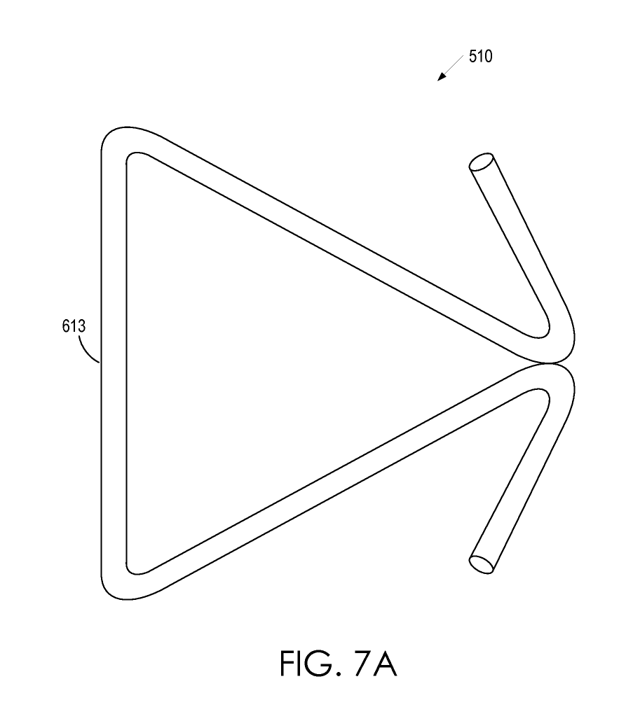

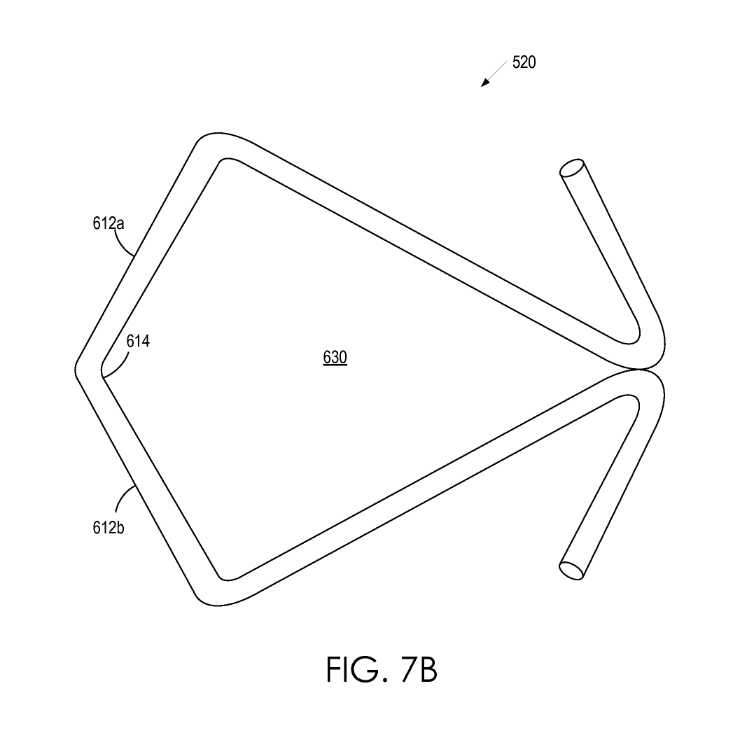

FIGS. 7A-10B illustrate additional embodiments of a fastener device. Each of the various embodiments may employ any of the features or techniques described above with respect to the fastener device 100 of FIG. 2. Further, each of the features of the various embodiments may be combined to form further embodiments of a fastener device.

FIG. 7A illustrates an embodiment of a fastener device 510 including a single anchor segment 613. Whereas the fastener device 100 of FIG. 2 includes two anchor segments 112a-112b joined at a connection 114, the fastener device 510 includes a single, straight, and contiguous anchor segment 613.

FIG. 7B illustrates an embodiment of a fastener device 520 including two anchor segments 612a-612b. Whereas the fastener device 100 of FIG. 2 includes two anchor segments 112a-112b joined at connection 114 that forms an angle of less than 180 degrees outside the interior region 130, the fastener device 520 of FIG. 7B includes two anchor segments 612a-612b joined at a connection 614 that forms an angle of less than 180 degrees inside the interior region 630.

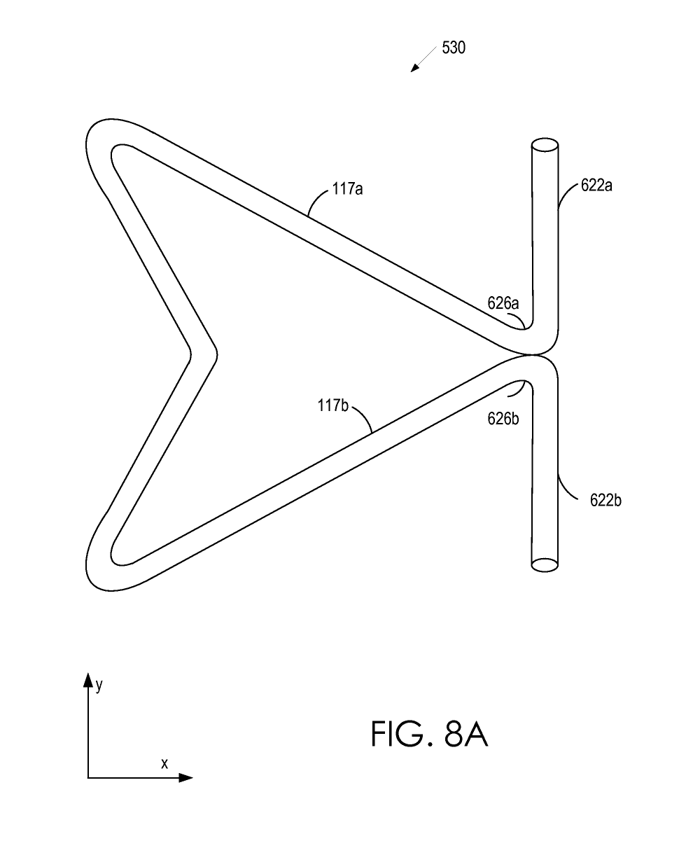

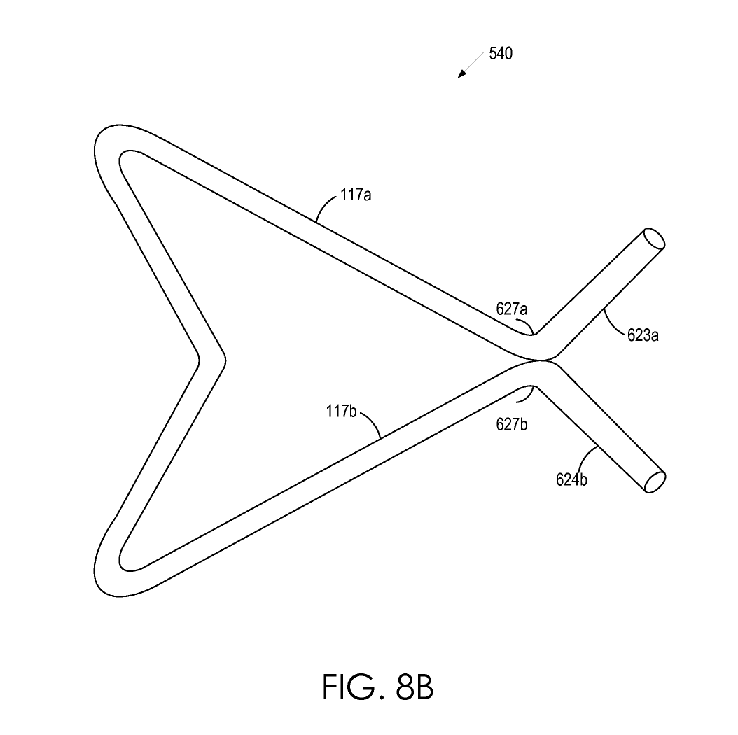

FIG. 8A illustrates an embodiment of a fastener device 530 including catch segments perpendicular to an axis of symmetry. Whereas the fastener device 100 of FIG. 2 includes two catch segments 122a-122b that form a less than 90 degree angle with an axis of symmetry (e.g., the x-axis in FIG. 2) at connections 126a-126b with coupler segments 117a-117b, the fastener device 530 of FIG. 8A includes two catch segments 622a-622b that form a 90 degree angle with an axis of symmetry (e.g., the x-axis in FIG. 8A) at connections 626a-626b with the coupler segments 117a-117b.

FIG. 8B illustrates an embodiment of a fastener device 540 including catch segments forming greater than 90 degree angles. Whereas the fastener device 100 of FIG. 2 includes two catch segments 122a-122b that form a less than 90 degree angle at connections 126a-126b with coupler segments 117a-117b, the fastener device 540 of FIG. 8B includes two catch segments 623a-623b that form a greater than 90 degree angle at connections 627a-627b with the coupler segments 117a-117b.

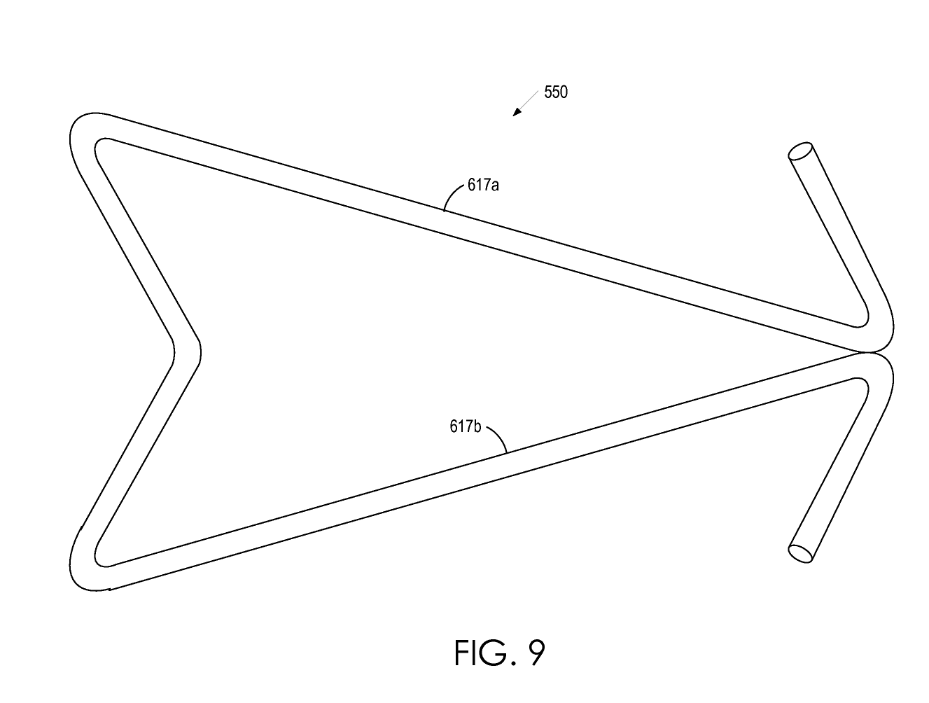

FIG. 9 illustrates an embodiment of a fastener device 550 with extended coupler segments 617a-617b. Whereas the fastener device 100 of FIG. 2 includes coupler segments 117a-117b of a length such that the fastener device is generally square-shaped, the fastener device 550 of FIG. 9 includes extended coupler segments 627a-627b of a longer length. The fastener device 550 may be used as an extender such as may be used for the waistband of pants or shorts.

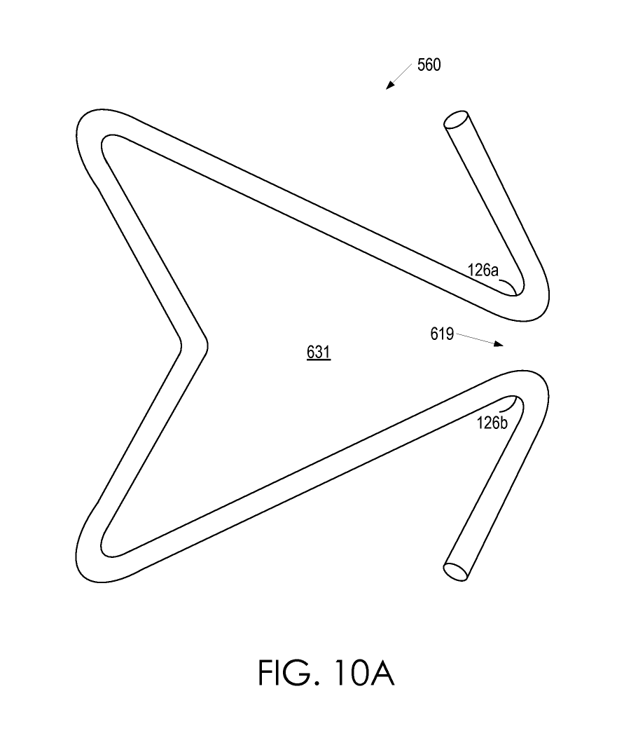

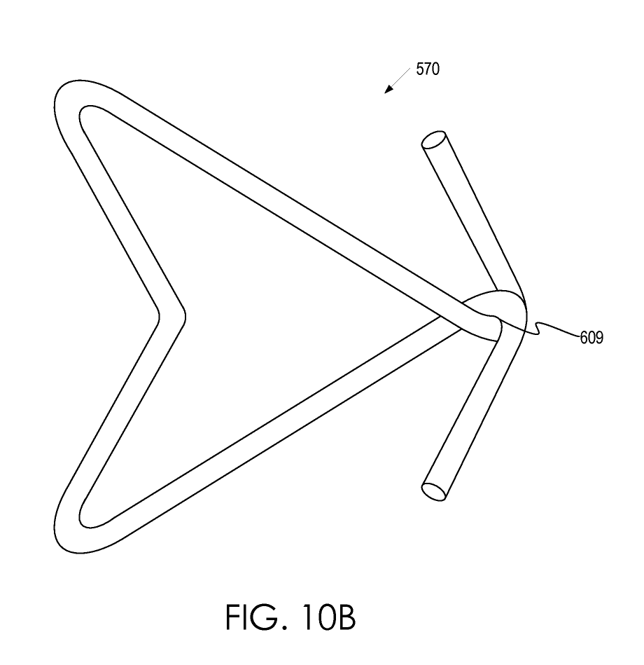

FIG. 10A illustrates an embodiment of a fastener device 560 with an open interior region 631. Whereas the fastener device 100 of FIG. 2 includes a closed interior region 130 due to the catch-coupler connections 126a-126b touching at a coupler-coupler connection 119, the fastener device 560 of FIG. 10A include an open interior region 631 due to the catch-coupler connections 126a-126b being spaced apart at a space 619.

FIG. 10B illustrates an embodiment of a fastener device 570 with connections that cross at a crossing 609. Whereas the fastener device 100 of FIG. 2 includes a closed interior region 130 due to the catch-coupler connections 126a-126b touching at a coupler-coupler connection 119, the fastener device 570 of FIG. 10B includes a closer interior region due to the catch-coupler connections being crossing over each other at a crossing 609.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

The above description sets forth numerous specific details such as examples of specific systems, components, methods and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A fastener device comprising:
two generally S-shaped portions defining a generally heart-shaped interior region, the S-shaped portions each comprising an anchor segment connected to a coupler segment that is connected to a catch segment,
wherein the connection between the anchor segment and the coupler segment defines an anchor angle of less than 90 degrees and the connection between the catch segment and the coupler segment defines a catch angle of less than 90 degrees,
wherein the anchor segments are connected to define a bridge angle outside the interior region of less than 180 degrees.

2. The fastener device of claim 1, wherein the fastener device comprises a single piece of homogenous material.

3. The fastener device of claim 1, wherein the fastener device is a solid cylindrical metal wire.

4. The fastener device of claim 1, wherein a length of the coupler segments is approximately twice a length of the catch segments.

5. The fastener device of claim 1, wherein a length of the coupler segments is greater than five times a length of the catch segments.

6. The fastener device of claim 1, wherein the catch segments are approximately parallel to the anchor segments.

7. The fastener device of claim 1, wherein the connections between the catch segments and the coupler segments touch.

8. The fastener device of claim 1, wherein free ends of the catch segments are machined smooth or polished to define caps.

9. The fastener device of claim 1, wherein free ends of the catch segments are coated with plastic or polypropylene.

10. The fastener device of claim 9, wherein the entire fastener device is coated with plastic or polypropylene.

11. A method of manufacturing a fastener device, the method comprising:
bending a workpiece in a first direction at a first location approximately at the center of the workpiece to define a bridge angle;
bending the workpiece in a second direction opposite the first direction at two second locations between free ends of the workpiece and the first location to define anchor angles of less than 90 degrees; and
bending the workpiece in the first direction at two third locations between the free ends of the workpiece and the second locations to define catch angles of less than 90 degrees.

12. The method of claim 11, wherein the workpiece comprises a solid cylindrical metal wire.

13. The method of claim 12, wherein the solid cylindrical metal wire is 12 to 14 gauge steel wire.

14. The method of claim 11, wherein the bridge angles are approximately 100-110 degrees.

15. The method of claim 11, wherein the catch angles are approximately 20-40 degrees.

16. The method of claim 11, further comprising machining smooth or polishing the free ends of the workpiece to define caps.

17. The method of claim 11, further comprising coating at least a portion of the workpiece with plastic or polypropylene.
